(19) United States
(12) Patent Application Publication
(10) Pub. No.: US 2026/0333321 A1
(43) Pub. Date: Oct. 22, 2026

(54) METHODS, COMMUNICATIONS DEVICES, AND NETWORK INFRASTRUCTURE EQUIPMENT

(71) Applicant: Sony Group Corporation, Tokyo (JP)

(72) Inventors: Yassin Aden AWAD, Basingstoke (GB); Shin Horng WONG, Basingstoke (GB); Naoki KUSASHIMA, Basingstoke (GB)

(73) Assignee: Sony Group Corporation, Tokyo (JP)

(21) Appl. No.: 19/113,918

(22) PCT Filed: Sep. 18, 2023
(86) PCT No.: PCT/EP2023/075618

§ 371 Date: Mar. 21, 2025

(30) Foreign Application Priority Data
Sep. 28, 2022 (EP) 22198470.1

(51) Int. Cl. H04W 72/0453; H04L 5/00; H04L 5/14; H04W 72/0457

(52) U.S. Cl. CPC H04W 72/0453; H04L 5/0012; H04L 5/14; H04W 72/0457

(57) ABSTRACT

Methods, communications devices, infrastructure equipment, and circuitry are provided for determining whether to enable frequency hopping for a given portion of an uplink transmission. It is determined whether to perform frequency hopping for a plurality of portions of a uplink transmission to be transmitted in one or more uplink sub-bands of the one or more slots. The determination may be made, for example, based on a threshold sub-band width or a semi-static configuration. As such, frequency hopping may be performed only for a portion of an uplink transmission, or not at all.

The present application claims the Paris Convention priority of European patent application EP22198470.1, filed 28 Sep. 2022, the contents of which are hereby incorporated by reference.

### BACKGROUND

### Field of Disclosure

The present disclosure relates to a communications device, network infrastructure equipment and methods of operating a communications device to receive data from a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Modern mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Wireless communications networks are expected to routinely and efficiently support communications with an ever-increasing range of devices associated with a wide range of data traffic profiles and types. For example, it is expected that wireless communications networks efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is a desire for current generation wireless communications networks, for example those referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

According to a first aspect of the invention, there is provided: a method for a communications device configured to transmit signals to and/or to receive signals from an infrastructure equipment of a wireless communications network via a wireless radio interface provided by the wireless communications network, the method comprising: identifying a sub-band format for one or more slots, the one or more slots having a plurality of sub-bands allocated to uplink and or downlink transmissions; determining whether to perform frequency hopping for a plurality of portions of an uplink transmission to be transmitted in one or more uplink sub-bands of the one or more slots; if it is determined that frequency hopping is to be performed for a respective portion of the uplink transmission, identifying a frequency hopping offset and performing frequency hopping for the uplink transmission based on the frequency hopping offset; and if it is determined that hopping is not to be performed for the respective portion of the uplink transmission, transmitting the respective portion of the uplink transmission using a set of resource blocks for the uplink transmission.

According to a second aspect of the invention, there is provided: a method of operating an infrastructure equipment configured to transmit signals to and/or receive signals from a plurality of communications devices via a wireless access interface provided by a wireless communications network, the method comprising: identifying a sub-band format for one or more slots, the one or more slots having a plurality of sub-bands allocated to uplink and or downlink transmissions; determining whether to perform frequency hopping for a plurality of portions of an uplink transmission to be transmitted in one or more uplink sub-bands of the one or more slots; if it is determined that frequency hopping is to be performed for a respective portion of the uplink transmission, identifying a frequency hopping offset and performing frequency hopping for the uplink transmission based on the frequency hopping offset; and if it is determined that hopping is not to be performed for the respective portion of the uplink transmission, transmitting the respective portion of the uplink transmission using a set of resource blocks for the uplink transmission.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates an example of frequency hopping in accordance with particular wireless network arrangements.

FIG. 5 illustrates an example division of system bandwidth into dedicated uplink and downlink sub-bands in Subband Full Duplex (SBFD);

FIG. 6 illustrates an example of a SBFD slot containing multiple uplink sub-bands of different widths.

FIG. 7 illustrates an example of frequency hopping within an SBFD slot with different sub-band widths.

FIG. 8 illustrates an example of frequency hopping within only select portions of an SBFD slot with different sub-band widths.

FIG. 9A illustrates an example of including additional demodulation reference signals (DMRS) within different hops of an uplink transmission.

FIG. 9B illustrates an example of including additional demodulation reference signals (DMRS) within select hops of an uplink transmission.

FIG. 10 illustrates an example sub-band configuration with semi-statically configured frequency hopping.

### DETAILED DESCRIPTION OF THE EMBODIMENTS

### Long Term Evolution Advanced Radio Access Technology (4G)

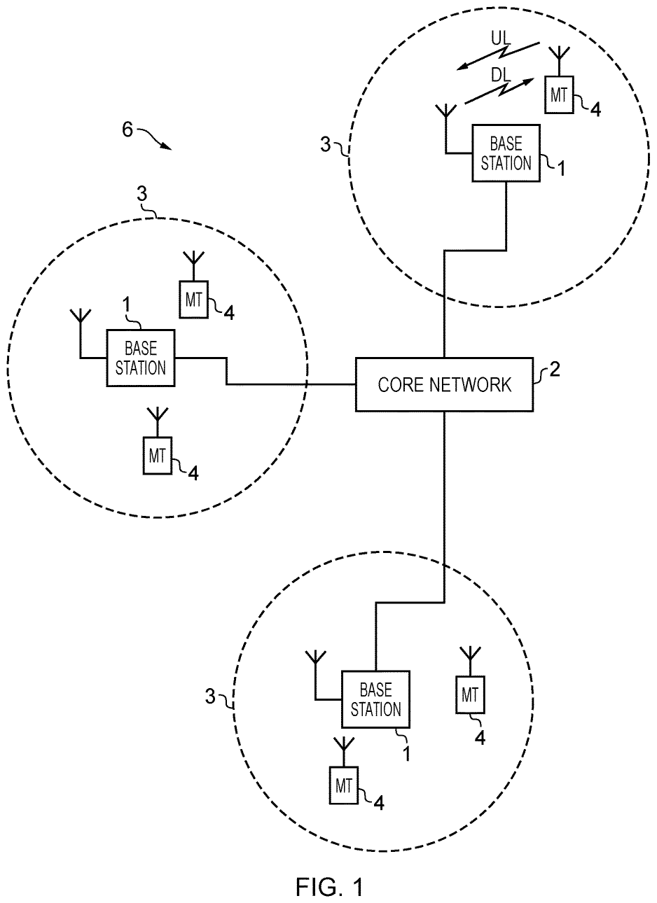

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices or mobile terminals (MT) 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. The communications or terminal devices 4 may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G (NR))

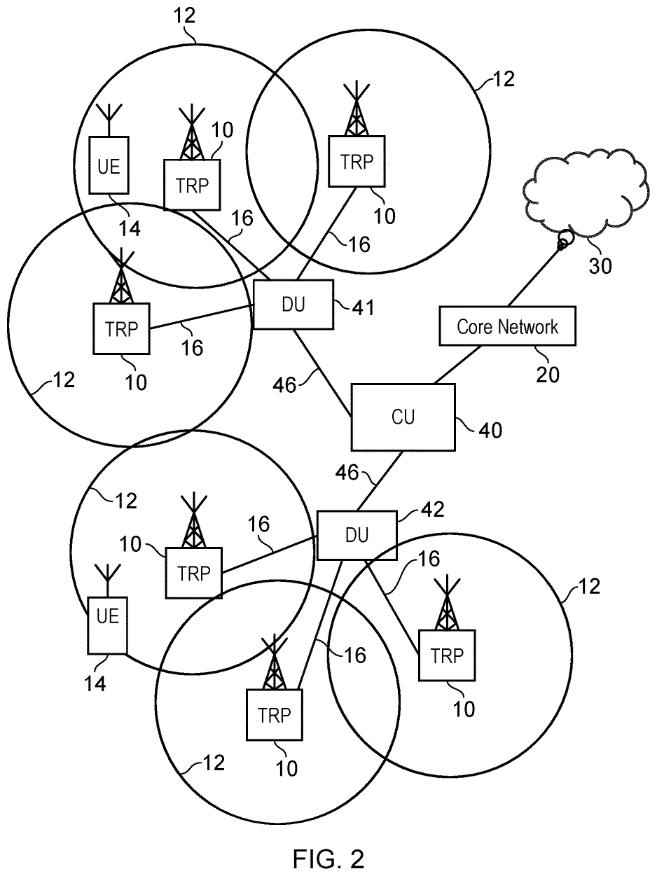

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

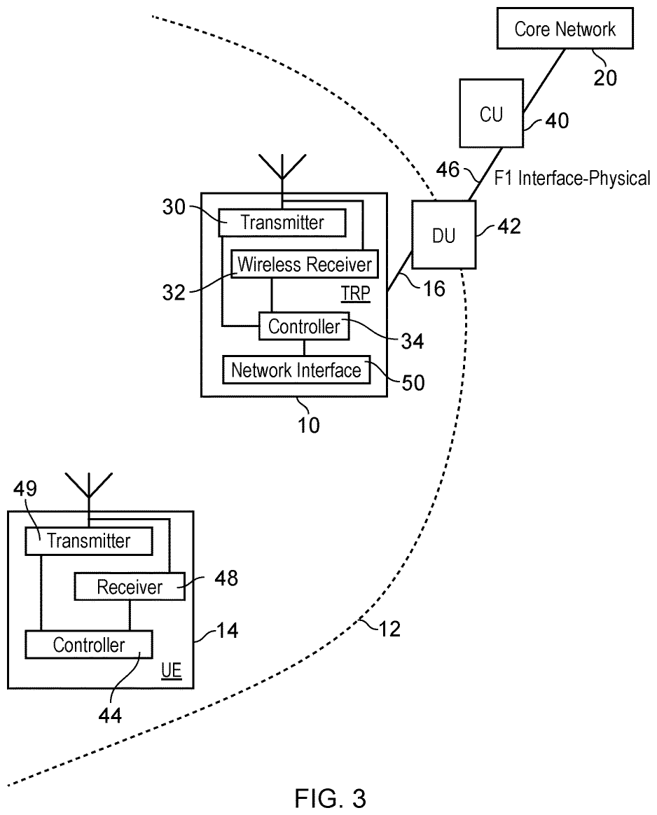

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Full Duplex Time Division Duplex (FD-TDD)

NR/5G networks can operate using Time Division Duplex (TDD), where an entire frequency band or carrier is switched to either downlink or uplink transmissions for a time period and can be switched to the other of downlink or uplink transmissions at a later time period. Currently, TDD operates in Half Duplex mode (HD-TDD) where the gNB or UE can, at a given time, either transmit or receive packets, but not both at the same time. As wireless networks transition from NR to 5G-Advanced networks, a proposed new feature of such networks is to enhance duplexing operation for Time Division Multiplexing (TDD) by enabling Full Duplex operation in TDD (FD-TDD) [2]. In FD-TDD, a gNB can transmit and receive data to and from the UEs at the same time on the same frequency band or carrier. In addition, a UE can operate either in HD-TDD or FD-TDD mode, depending on its capability. For example, when UEs are only capable of supporting HD-TDD, FD-TDD is achieved at the gNB by scheduling a downlink (DL) transmission to a first UE and scheduling an uplink (UL) transmission from a second UE within the same orthogonal frequency division multiplexing (OFDM) symbol (i.e. at the same time). Conversely, when UEs are capable of supporting FD-TDD, FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD. Development of current 5G networks is focused primarily on enabling FD-TDD at the gNB with UEs operating in HD-TDD mode.

Motivations for enhancing duplexing operation for TDD include an improvement in system capacity, reduced latency, and improved uplink coverage. For example, in current HD-TDD systems, OFDM symbols are allocated only for either a DL or UL direction in a semi-static manner. Hence, if one direction experiences less or no data, the spare resources cannot be used in the other direction, or are, at best, under-utilized. However, if resources can be used for DL data and UL data (as in FD-TDD) at the same time, the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition, UEs are usually limited in the UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would help allow a UE to be assigned more UL time resources when required, without sacrificing DL time resources.

### Frequency Hopping

Frequency hopping (FH) is a technique for improving signal-to-noise ratio (SNR) for a transmitted radio signal (i.e. data) via channel diversity and interference averaging. Usually the bandwidth of the radio signal using frequency hopping is a narrow-band which is transmitted over a wide-band radio channel. For example, in NR if the system carrier bandwidth is 100 RBs, the bandwidth of the transmitted data using frequency hopping can be 10 RBs or less. Frequency hopping schemes are useful for UEs suffering from bad channel condition or interference from other cells/users, more specifically when channel state information (CSI) is not accurate or not available at the gNB scheduler.

Legacy networks support an UL frequency hopping scheme where a UE is configured with frequency hopping for a dynamically scheduled (DG) PUSCH or configured grant (i.e. UL Grant free) transmission by the higher layer ‘frequency-hopping’ parameter [3]. One of two frequency hopping modes can be configured:
Intra-slot frequency hopping, applicable to both single slot and multi-slot PUSCH transmissions.
Inter-slot frequency hopping, applicable to multi-slot PUSCH transmissions.

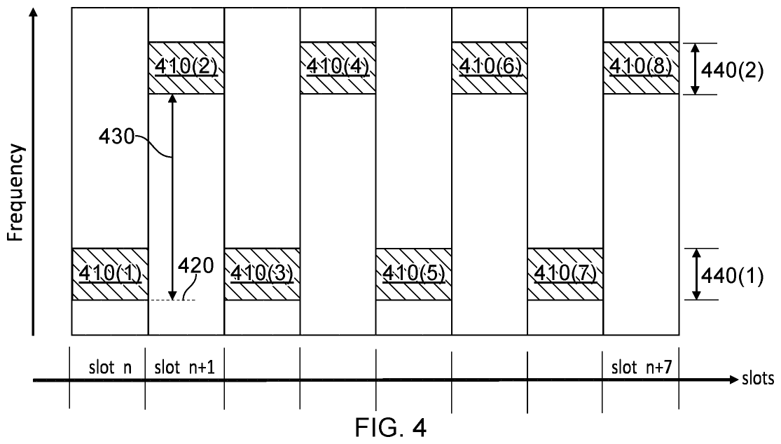

An example of inter-slot frequency hopping is shown in FIG. 4. A DG PUSCH 410 is scheduled across slots n to n+7. A first portion of the DG PUSCH 410(1) has a starting resource block (RB) 420 in slot n and uses a first set of RBs 440(1). Then, a second portion of the DG PUSCH 410(2) in slot n+1 has a starting RB that is offset from the starting RB for the first portion of the DG PUSCH 410(1) by an offset about 430, and as such uses a second set of RBs 440(2). The subsequent portions 420(3)-(8) of the DG PUSCH may then subsequently hop between these two sets of RBs 440(1) and 440(2).

For a DG PUSCH and a configured grant (CG) Type 2 PUSCH, two or more frequency offsets are configured by higher layers in advance (during activation by the DG), and then the DG indicates one of the configured offsets is to be used at a given time. However, for CG Type 1, a single frequency offset is provided by the higher layer semi-statically.

For intra-slot frequency hopping, the starting RB in each hop is given by:

$${RB}_{start} = \{ \begin{matrix}{RB}_{start} & i = 0 \\ ( {RB}_{start} + {RB}_{offset} ) mod {N}_{BWP}^{size} & i = 1\end{matrix}$$

where i=0 and i=1 are the first hop and the second hop respectively, RBₛₜₐᵣₜ is the starting RB within the UL BWP, as calculated from the resource block assignment information of resource allocation type 1 (as discussed in sub-clause 6.1.2.2.2 of [3]), and RB_{offset} is the frequency offset in RBs between the two frequency hops.

In case of inter-slot frequency hopping, the starting RB during slot nₛ^{μ} is given by:

$$R {B}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} ,$$

where nₛ^{μ} is the current slot number within a radio frame where a multi-slot PUSCH transmission can take place, RBₛₜₐᵣₜ is the starting RB within the UL BWP, as calculated from the resource block assignment information of resource allocation type 1 (as discussed in sub-clause 6.1.2.2.2 of [3]) and RB_{offset} is the frequency offset in RBs between the two frequency hops. As captured above, NR frequency hopping modes support only two hops.

### Subband Full Duplex (SBFD)

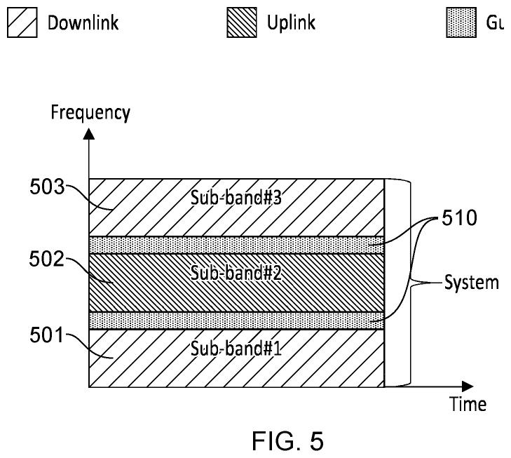

In some implementations, the system (i.e. UE/gNB) bandwidth is divided into non-overlapping sub-bands 501-503 allocated to UL or DL, as shown in FIG. 5, where simultaneous DL and UL transmissions may occur in different sub-bands 501-503, i.e. in different sets of frequency Resource Blocks (RB). This may be referred to as Subband Full Duplex (SBFD). While FIG. 5 shows the system bandwidth as being divided into three sub-bands, substantially any number of sub-bands could be used. For example, the system bandwidth may be divided into four sub-bands, which may include two downlink sub-bands and two uplink sub-bands, however other sub-band arrangements are envisioned.

In some implementations, a guard sub-band 510 may be configured between UL and DL sub-bands 501-503. An example is shown in FIG. 5, where a TDD system bandwidth is divided into three sub-bands 501, 502, 503: Sub-band #1 501, Sub-band #2 502 and Sub-band #3 503, such that Sub-band #1 501 and Sub-band #3 503 are used for DL transmissions whilst Sub-band #2 502 is used for UL transmissions. Guard sub-bands 510 are configured between DL Sub-band #3 503 and UL Sub-band #2 502 and between UL Sub-band #2 502 and DL Sub-band #1 501. The arrangement of sub-bands 501-503 shown in FIG. 5 is just one possible arrangement of the sub-bands and other arrangements are possible, and guard bands may be used in substantially any sub-band arrangement.

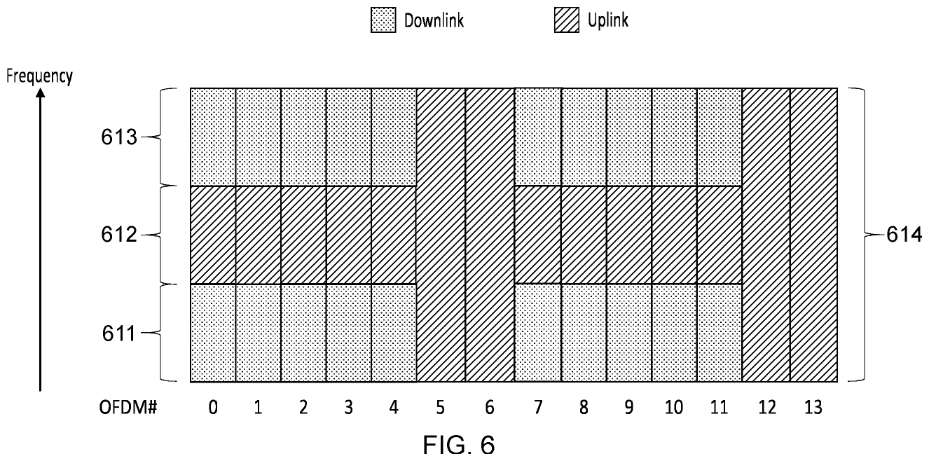

SBFD may not necessarily be configured for all slots or OFDM symbols. That is, in some slots or OFDM symbols, there are no sub-bands and they are either fully downlink or uplink, whilst in other slots or OFDM symbols SBFD is configured where there are DL and UL sub-bands. An example of such an arrangement is shown in FIG. 6 where a slot having OFDM symbols 0-13 is configured with SBFD including two DL sub-bands 611, 613 and one UL sub-band 612 (i.e. {D,U,D}) in OFDM symbols 0-4 and 7-11, while OFDM symbols 5, 6, 12, and 13 are fully UL. In other words, the UL RBs change depending on whether SBFD is configured or not for a given OFDM symbol. It is also possible that the sub-bands may have different sizes both within a single slot and in different slots.

This slot structure shown in FIG. 6 may be expressed as a slot having multiple UL sub-bands of different sizes. For example, FIG. 6 can be described in terms of the slot having two UL sub-bands 612 and 614, where sub-band 614 is a special case where the entire bandwidth contains only UL resources.

As discussed above, legacy frequency hopping occurs between two resources (hops) where the offset between them is dynamically provided by a DCI (if dynamically scheduled) or semi-statically configured by higher layers (if CG resources are used). However, when multiple different sub-band sizes are implemented with SBFD, frequency hopping cannot be implemented using legacy techniques. As such, modifications to existing frequency hopping methods are required in order to allow UL sub-bands of different sizes in SBFD.

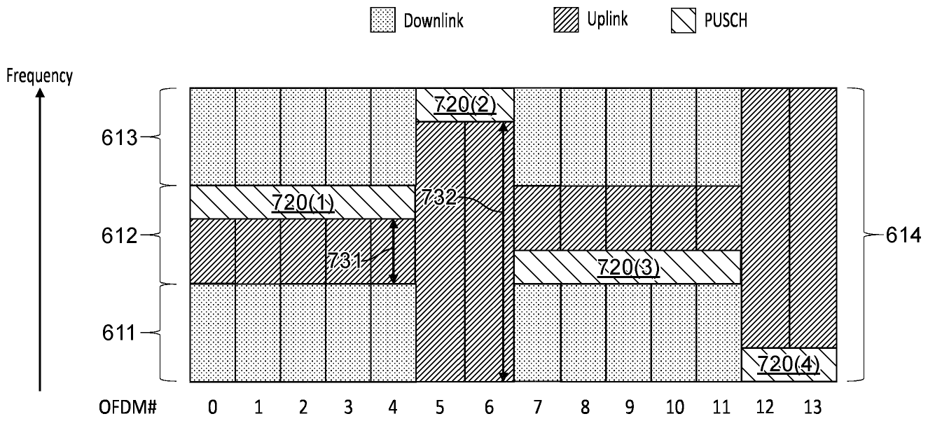

In some examples, an RB offset may be configured separately for each UL sub-band. Accordingly, frequency hopping can be contained within a particular UL sub-band (i.e. the frequency hopping uses only allocated UL resources, regardless of the size of the UL sub-bands). An example of this arrangement is shown in FIG. 7, which uses the same slot and sub-band format as that shown in FIG. 6. In FIG. 7, a PUSCH 720 is transmitted in the shown slot, across OFDM symbols 0-13. A first portion 720(1) of the PUSCH is transmitted in OFDM symbols 0-4 within sub-band 612, a second portion 720(2) of the PUSCH is transmitted in OFDM symbols 5-6 within sub-band 614, a third portion 720(3) of the PUSCH is transmitted in OFDM symbols 7-11 within sub-band 612, and a fourth portion 720(4) of the PUSCH is transmitted in OFDM symbols 12-13 within sub-band 614. While the teachings of the present disclosure are primarily described in relation to PUSCH transmissions, the techniques described herein are also applicable to other types of uplink transmissions, such as a Physical Uplink Control Channel (PUCCH).

As shown, the first portion 720(1) and the third portion 720(3), both in sub-band 612, are offset from one another by a first frequency hopping offset 731, and the second portion 720(2) and the fourth portion 720(4), both in sub-band 614, are offset from one another by a second frequency hopping offset 732 which is different to the first frequency hopping offset 731. As such, the frequency hopping offset (and the RBs used) is different for different sub-bands. However, in some sub-bands it may not be possible or beneficial to perform frequency hopping. For example, if a particular UL sub-band is very small in size, there may be no significant gain from frequency hopping. Similarly, if an UL transmission utilises the entire width of a particular UL sub-band, it is not possible to perform frequency hopping, as all UL RBs are used. Therefore, the above approach may lead to errors and inefficiencies.

According to example teachings of the disclosure, there is provided a method that allows frequency hopping to operate in an environment where uplink resources change during the frequency hopping duration. As such, frequency hopping may be performed regardless of whether a given slot or OFDM symbol is an SBFD slot/OFDM symbol (i.e. regardless of whether the slot/OFDM symbol contains multiple sub-bands).

In an example teaching of the disclosure, it is determined whether frequency hopping should be performed for a plurality of portions of an uplink transmission. That is, one or more criteria are used to determine whether frequency hopping should be performed for a given slot, particular OFDM symbols of a slot, or hop. These criteria may include a threshold sub-band width, which may be predetermined. Accordingly, if the width of a sub-band is below the threshold width, frequency hopping may not be performed for that slot/OFDM symbols/hop. Conversely, if the width of the sub-band meets the threshold (i.e. the sub-band width is equal to or above the threshold) frequency hopping may be performed within for that slot/OFDM symbols/hop.

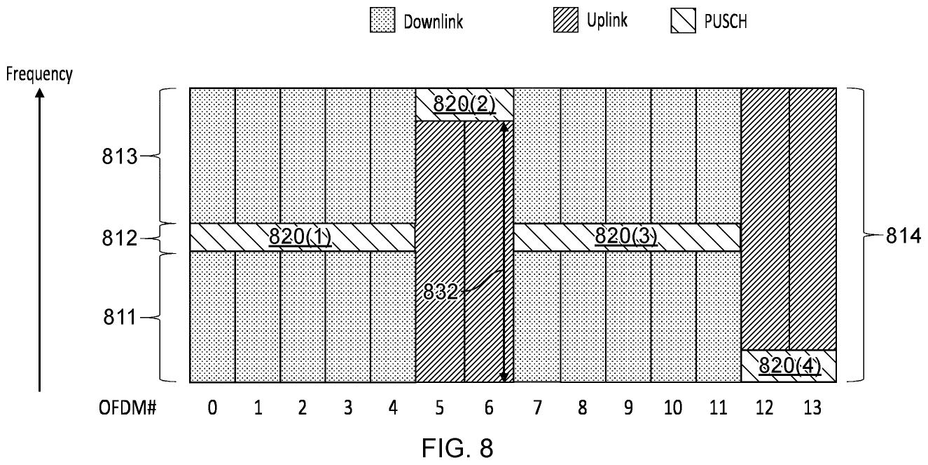

An example of this arrangement is shown in FIG. 8. In FIG. 8, two downlink sub-bands 811 and 813 are provided, and two uplink sub-bands 812 and 814 are provided. OFDM symbols 0-4 and 7-11 include DL sub-bands 811, 813 and UL sub-band 812 (i.e. {D,U,D}), while OFDM symbols 5, 6, 12, and 13 are fully UL (i.e. sub-band 814). A first portion 820(1) of a PUSCH 820 is transmitted in OFDM symbols 0-4 within sub-band 812, a second portion 820(2) of the PUSCH is transmitted in OFDM symbols 5-6 within sub-band 814, a third portion 820(3) of the PUSCH is transmitted in OFDM symbols 7-11 within sub-band 812, and a fourth portion 820(4) of the PUSCH is transmitted in OFDM symbols 12-13 within sub-band 814.

In the example of FIG. 8, sub-band 812 has a width of 10 RBs, while a frequency hopping threshold width of 15 RBs may be used. Therefore, as the width of sub-band 812 is below the frequency hopping threshold width, frequency hopping is not used within sub-band 812, meaning that frequency hopping is not applied to the first portion 820(1) and third portion 820(3) of the PUSCH, such that the first portion 820(1) and third portion 820(3) of the PUSCH utilise the same RBs. However, sub-band 814 in which the second portion 820(2) and fourth portion 820(4) of the PUSCH are transmitted has a width of 50 RBs. Therefore, as the width of sub-band 814 is above the frequency hopping threshold width, frequency hopping is used within sub-band 814, meaning that frequency hopping is applied to the second portion 820(2) and fourth portion 820(4) of the PUSCH, such that the second portion 820(2) and fourth portion 820(4) in the same sub-band 814 are offset from one another by an offset amount 832. In the example of FIG. 8, the PUSCH 820 utilises all RBs of sub-band 812 (i.e. uses the entire width of sub-band 812), however this is just one example and the PUSCH may utilise only a subset of RBs within sub-band 812 and frequency hopping may still be disallowed if the width of sub-band 812 is below the threshold width. Furthermore, sub-band 814 is shown as covering the entire system bandwidth, however sub-band 814 may instead cover only a subset of the system bandwidth.

In some examples, the UE may determine not to perform frequency hopping based on an amount of resources in a UL sub-band that are not utilised by the UL transmission. For example, the UE may determine whether at least a width (e.g. in RBs) of the UL transmission is unused in a given sub-band. As an example implementation, in the arrangement of FIG. 8, the UE may determine that the PUSCH has a width of 10 RBs and may determine that for sub-band 812, there are not at least 10 RBs that are not used by the PUSCH 820. Accordingly, the UE may disable frequency hopping for sub-band 812. The UE may also determine that there are at least 10 RBs that are unused by the PUSCH 820 in sub-band 814, and as such may permit frequency hopping for sub-band 814. Therefore, in some implementations, the threshold sub-band width (above which frequency hopping may be permitted) may be double the width of the uplink transmissions. Accordingly, the threshold width may be different for different uplink transmissions. In other examples, when determining whether the uplink transmission utilises all of the available resources of a UL sub-band. For example, the UE may determine for sub-band 812 that the PUSCH 820 spans the entire width of sub-band 812 (i.e. uses all the RBs of sub-band 812) and may therefore disable frequency hopping sub-band 812. The UE may conversely determine that the PUSCH 820 does not span the entire width of sub-band 814, and may therefore permit frequency hopping for sub-band 814.

The frequency hopping threshold may take any suitable value. For example, the threshold may be a fixed number of RBs, such as 5 RBs, 10 RBs, 15 RBs, 20 RBs, 25 RB, 30 RBs, or substantially any number of RBs, and may be determined according to the system bandwidth. The frequency hopping threshold may also be defined as a percentage or proportion of the total system bandwidth. The frequency hopping threshold width may be determined by the UE in a number of ways. For example, the threshold may be signalled to the communications device from an infrastructure equipment (i.e. base station), for example via higher layer signalling. The threshold may also be fixed (i.e. fixed in technical specifications), such that no such signalling is required.

As briefly discussed above, different frequency hopping parameters may be configured for different UL sub-bands. For example, two different frequency offset RB_{Offset1} and RB_{Offset2}, may be configured, where RB_{Offset1} is used in a 1^{st} UL sub-band and RB_{Offset2} is used in a 2^{nd} UL sub-band. The 1^{st} and 2^{nd} UL sub-bands have different sizes, and the 2^{nd} UL sub-band can, in some cases, span the entire system bandwidth, i.e. the 2^{nd} UL sub-band can be a full UL slot/OFDM symbol. In cases where different frequency hopping parameters may be configured for different UL sub-bands, there may be separate PUSCH configurations for UL sub-bands for SBFD slots and for non-SBFD slots (i.e. when a slot is fully allocated to UL). That is, non-SBFD symbols may use legacy frequency hopping configurations from the legacy PUSCH configuration parameters, and the SBFD slot may provide a frequency hopping configuration using a separate PUSCH configuration. Alternatively, modifications to existing PUSCH configurations may be made to define separate frequency hopping offsets for SBFD and non-SBFD symbols within a single PUSCH configuration. In both cases, the frequency hopping threshold may be included within the frequency hopping parameters of a PUSCH configuration.

Furthermore, the frequency hopping configurations may include the frequency hopping offsets for the UL sub-bands. However, in some examples, the UE may determine the frequency hopping offsets based on a size of a respective UL sub-band. For example, the UE may determine a scaling factor in order to determine the offset(s). Accordingly, a UE may identify a ratio of the size of a UL sub-band to the system bandwidth and may then apply this ratio to a frequency hopping offset for the entire system bandwidth. For example, if the system bandwidth is 100 RBs and an UL sub-band is 50 RBs, the UE may determine the scaling factor to be 0.5. As such, if the UE receives a legacy frequency hopping offset value of 60 RBs (to be applied for non-SBFD slots/symbols), the UE may multiply 60 RBs by 0.5 to identify an UL sub-band offset of 30 RBs.

Frequency hopping is not applied to the portions of a PUSCH where the sub-band width is below the threshold as there may be no significant diversity gain in doing so, or frequency hopping may not be possible as there are no unallocated RBs. It should also be appreciated that there is channel discontinuity between two frequency hops, since the channel condition for a portion of a PUSCH in one frequency may be different to the channel condition of another portion of a PUSCH in another frequency. As such, demodulation reference signals (DMRS) may be required for each different frequency hop portions of the PUSCH. Including additional DMRS consumes resources and hence including these additional resources if there is no significant gain in using frequency hopping is undesirable.

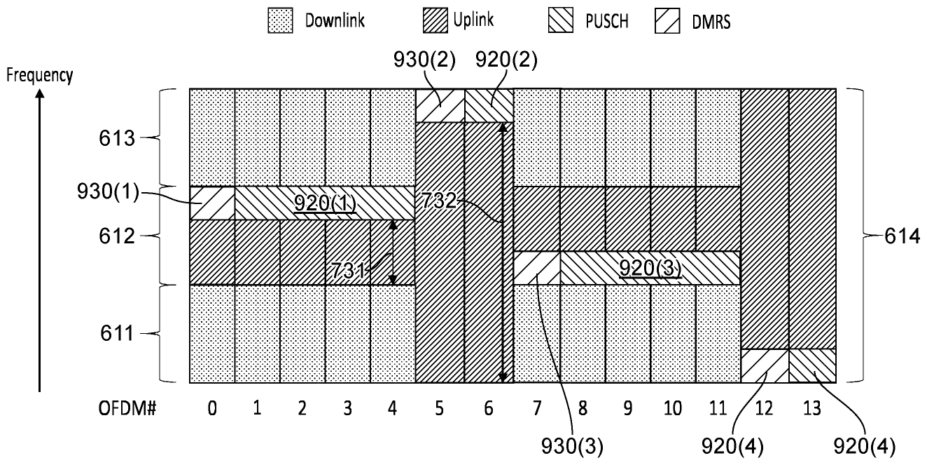

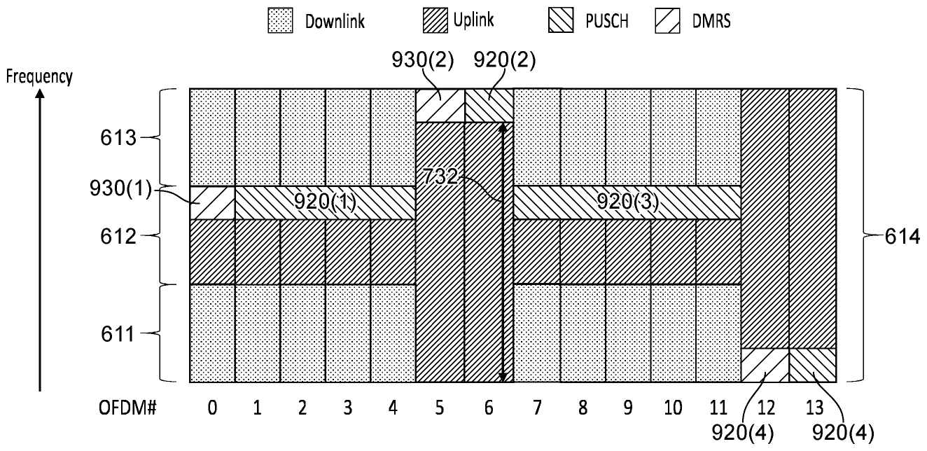

This arrangement is illustrated in FIGS. 9A and 9B. In FIG. 9A, the format of the sub-bands is identical to FIG. 7, where frequency hopping is performed for the PUSCH 920 is sub-bands 612 and 614, such that the first portion 920(1) of the PUSCH in OFDM symbols 0-4 is offset from the third portion 920(3) of the PUSCH in OFDM symbols 7-11 by a first offset amount 731, and the second portion 920(2) of the PUSCH in OFDM symbols 5-6 is offset from the fourth portion 920(4) of the PUSCH in OFDM symbols 12-12 by a second offset amount 732.

First portion 920(1) includes first DMRS 930(1) in at least the first OFDM symbol (symbol 0) of the first portion 920(1). As the second portion 920(2) utilises different RBs to the first portion 920(1), the second portion 920(2) also includes DMRS (second DMRS) 930(2) in at least the first OFDM symbol of the second portion 920(2) (symbol 5). As the third portion 920(3) utilises different RBs to the first portion 920(1) and the second portion 920(2), the third portion 920(3) also includes DMRS (third DMRS) 930(3) in at least the first OFDM symbol of the third portion 920(3) (symbol 7). As the fourth portion 920(4) utilises different RBs to the first portion 920(1), the second portion 920(2), and the third portion 920(3), the fourth portion 920(4) also includes DMRS (fourth DMRS) 930(4) in at least the first OFDM symbol of the fourth portion 920(4) (symbol 12).

However, in some cases frequency hopping may not be performed in a particular sub-band, as discussed above. For example, in FIG. 9B frequency hopping is not performed for sub-band 612. As such, the second portion 920(2) of the PUSCH in OFDM symbols 5-6 is offset from the fourth portion 920(4) of the PUSCH in OFDM symbols 12-13 by the second offset amount 732, however frequency hopping is not performed for the first portion 920(1) and the third portion 920(3), such that the third portion 920(3) is transmitted using the same RBs as the first portion 920(1). As the third portion 920(3) is transmitted using the same RBs as the first portion 920(1), the UE has already transmitted DMRS 930(1) for the first portion 920(1), which allows a receiving device to carry out channel estimation for the PUSCH using the RBs of the first portion 920(1). Accordingly, a receiving device has already received the DMRS 930(1) necessary to carry out channel estimation for the third portion 920(3). Therefore, the third portion 920(3) is not provided with any additional DMRS, thereby improving resource utilisation/consumption.

As discussed above, a UE may determine whether to perform frequency hopping for a given portion or hop of an uplink transmissions based on whether a width of an uplink sub-band for that portion/hop meets a threshold width. However, in some examples, instead of comparing the sub-band width to a threshold, frequency hopping may be configured semi-statically, such that no threshold is required. In particular, while SBFD configurations (i.e. the frequency and time locations of sub-bands) may be dynamically configured, they may also be configured semi-statically. Accordingly, as the UL sub-band size and location may be known prior to a transmission by a UE, frequency hopping may also be enabled or disabled semi-statically.

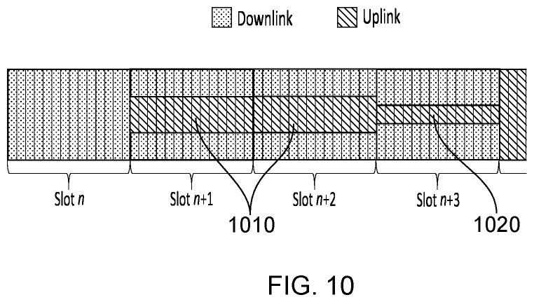

An example of this is illustrated in FIG. 10. Here, a base station has configured two semi-static SBFD configurations giving two possible UL sub-bands 1010 and 1020. The base station also semi-statically configures frequency hopping to be permitted for sub-band 1010 and that frequency hopping to be disabled for sub-band 1020. As such, for any UL transmission for which frequency hopping is enabled (e.g. via a PUSCH configuration), frequency hopping will be performed in sub-band 1010 (i.e. in slots n+1 and n+2), but will not be performed for sub-band 1020 (i.e. slot n+3). That is, frequency hopping may be generally enabled for an uplink transmission, but disabled for specific portions of the transmission, according to the semi-static configuration. The semi-static configuration may be defined for each different UL sub-band configuration, for each different SBFD configuration, or the semi-static configuration may be defined for a given slot or sub-slot (e.g. a predetermined number of OFDM symbols, such as two OFDM symbols or seven OFDM symbols).

While the foregoing techniques have been described primarily in terms of steps performed by a UE in relation to frequency hopping for an uplink transmission, the techniques described herein are equally applicable to network infrastructure equipment (e.g. transceiver stations, nodeBs, e-nodeBs, eNB, g-nodeBs, gNB) for downlink transmissions. That is, an infrastructure equipment may determine whether to perform frequency hopping for a portion of a downlink transmission is the same manner as described above for a UE in relation to an uplink transmission. Also, the techniques described herein are equally applicable for sidelink transmissions. This is, a UE operating on sidelink transmission may determine whether to perform frequency hopping for a portion of a sidelink transmission in the same manner as described above for a UE in relation to an uplink transmission.

Accordingly, there has been described methods, apparatus and circuitry for Methods, communications devices, infrastructure equipment, and circuitry are provided for determining whether to enable frequency hopping for a given portion of an uplink transmission. It is determined whether to perform frequency hopping for a plurality of portions of a uplink transmission to be transmitted in one or more uplink sub-bands of the one or more slots. The determination may be made, for example, based on a threshold sub-band width or a semi-static configuration. As such, frequency hopping may be performed only for a portion of an uplink transmission, or not at all.

The following numbered clauses provide further example aspects and features of the present technique:
1. A method for a communications device configured to transmit signals to and/or to receive signals from an infrastructure equipment of a wireless communications network via a wireless radio interface provided by the wireless communications network, the method comprising:
   identifying a sub-band format for one or more slots, the one or more slots having a plurality of sub-bands allocated to uplink and or downlink transmissions;
   determining whether to perform frequency hopping for a plurality of portions of an uplink transmission to be transmitted in one or more uplink sub-bands of the one or more slots;
   if it is determined that frequency hopping is to be performed for a respective portion of the uplink transmission, identifying a frequency hopping offset and performing frequency hopping for the uplink transmission based on the frequency hopping offset; and
if it is determined that hopping is not to be performed for the respective portion of the uplink transmission, transmitting the respective portion of the uplink transmission using a set of resource blocks for the uplink transmission.
2. The method of clause 1, further comprising:
   determining that frequency hopping is to be performed for a portion of the uplink transmission; and
   determining that frequency hopping is not to be performed for another portion of the uplink transmission.
3. The method according to clause 1 or 2, wherein the one or more slots include multiple uplink sub-bands of different widths.
4. The method according to clause 3, wherein the frequency hopping offset is different for different uplink sub-bands.
5. The method according to any preceding clause, wherein the one or more slots are one or more sub-band full duplex (SBFD) slots.
6. The method according to any preceding clause, wherein the one or more uplink sub-bands span an entire system bandwidth or bandwidth part (BWP).
7. The method according to any preceding clause, wherein the communications device derives the frequency hopping offset for an uplink sub-band based on a width of the uplink sub-band.
8. The method according to any preceding clause, wherein the frequency hopping offset is derived using a scaling factor.
9. The method according any preceding clause, wherein determining whether to perform frequency hopping comprises determining whether a width of an uplink sub-band for the respective portion of the uplink transmission is above a predetermined threshold sub-band width.
10. The method according to clause 9, wherein the predetermined threshold width is a fixed number of resource blocks.
11. The method according to clause 9 or clause 10, further comprising receiving the predetermined threshold width from an infrastructure equipment of the wireless communications network.
12. The method according to clause 11, wherein the predetermined threshold width is included within frequency hopping parameters of a configuration message for the uplink transmission.
13. The method according to any of clauses 1-8, wherein determining whether to perform frequency hopping comprises identifying whether frequency hopping is disabled for one or more portions of the uplink transmission according to a semi-static configuration.
14. The method according to clause 13, wherein the semi-static configuration defines whether frequency hopping is disabled for each sub-band configuration of the one or more uplink sub-bands.
15. The method according to clause 13, wherein the semi-static configuration defines whether frequency hopping is disabled for each of the one or more slots.
16. The method according to clause 13, wherein the semi-static configuration defines whether frequency hopping is disabled for each of a plurality of sub-slots, wherein the plurality of sub-slots are each a subset of OFDM symbols of a slot of the one or more slots.
17. The method according to any preceding clause, wherein determining whether to perform frequency hopping comprises determining, for the respective portion of the uplink transmission in an uplink sub-band, whether a number of resource blocks corresponding to a width of the uplink transmission are unused by another portion of the uplink transmission in the same uplink sub-band.
18. The method according to any preceding clause, wherein determining whether to perform frequency hopping comprises determining whether the respective portion of the uplink transmission utilises all resource blocks of an uplink sub-band.
19. The method according to any preceding clause, wherein the one or more portions each correspond to one or more orthogonal frequency division multiplexing (OFDM) symbols.
20. The method according to any preceding clause, wherein performing frequency hopping for the uplink transmission comprises performing frequency hopping within a single slot.
21. The method according to any preceding clause, wherein performing frequency hopping for the uplink transmission comprises performing frequency hopping across multiple slots.
22. The method according to any preceding clause, wherein a plurality of portions of the uplink transmission include one or more OFDM symbols allocated to demodulation reference signals (DMRS).
23. The method according to clause 22, wherein DMRS are included in respective portions of the uplink transmission for each frequency hop of the uplink transmission.
24. The method according to clause 22, wherein DMRS are included in respective portions of the uplink transmission for each frequency hop of the uplink transmission that utilises a particular set of resource blocks for a first time for the uplink transmission in a slot.
25. The method according to clause 22, wherein DMRS are included in respective portions of the uplink transmission for particular frequency hops of the uplink transmission, based on one or more transmissions from an infrastructure equipment of the wireless communications network.
26. The method according to any of clauses 22-25, wherein DMRS are included in respective portions of the uplink transmission based on a sub-band format corresponding to the respective portions of the uplink transmission.
27. The method according to any preceding clause, wherein the uplink transmission is a sidelink transmission.
28. A communications device, the communications device comprising:
   a transceiver configured to transmit signals to and/or to receive signals from an infrastructure equipment of a wireless communications network and/or one or more other communications devices, and
a controller configured in combination with the transceiver to:
identify a sub-band format for one or more slots, the one or more slots having a plurality of sub-bands allocated to uplink and or downlink transmissions;
   determine whether to perform frequency hopping for a plurality of portions of an uplink transmission to be transmitted in one or more uplink sub-bands of the one or more slots;
   if it is determined that frequency hopping is to be performed for a respective portion of the uplink transmission, identify a frequency hopping offset and performing frequency hopping for the uplink transmission based on the frequency hopping offset; and
if it is determined that hopping is not to be performed for the respective portion of the uplink transmission, transmit the respective portion of the uplink transmission using a set of resource blocks for the uplink transmission.
29. Circuitry for a communications device comprising:
transceiver circuitry configured to transmit signals to and/or to receive signals from an infrastructure equipment of a wireless communications network and/or one or more other communications devices, and
controller circuitry configured in combination with the transceiver to:
identify a sub-band format for one or more slots, the one or more slots having a plurality of sub-bands allocated to uplink and or downlink transmissions;
   determine whether to perform frequency hopping for a plurality of portions of an uplink transmission to be transmitted in one or more uplink sub-bands of the one or more slots;
   if it is determined that frequency hopping is to be performed for a respective portion of the uplink transmission, identify a frequency hopping offset and performing frequency hopping for the uplink transmission based on the frequency hopping offset; and
if it is determined that hopping is not to be performed for the respective portion of the uplink transmission, transmit the respective portion of the uplink transmission using a set of resource blocks for the uplink transmission.
30. A method of operating an infrastructure equipment configured to transmit signals to and/or receive signals from a plurality of communications devices via a wireless access interface provided by a wireless communications network, the method comprising:
   identifying a sub-band format for one or more slots, the one or more slots having a plurality of sub-bands allocated to uplink and or downlink transmissions;
   determining whether to perform frequency hopping for a plurality of portions of an uplink transmission to be transmitted in one or more uplink sub-bands of the one or more slots;
   if it is determined that frequency hopping is to be performed for a respective portion of the uplink transmission, identifying a frequency hopping offset and performing frequency hopping for the uplink transmission based on the frequency hopping offset; and
if it is determined that hopping is not to be performed for the respective portion of the uplink transmission, transmitting the respective portion of the uplink transmission using a set of resource blocks for the uplink transmission.
31. An infrastructure equipment comprising:
   a transceiver configured to transmit signals to and/or receive signals from a plurality of communications devices, and
a controller configured in combination with the transceiver to:
identify a sub-band format for one or more slots, the one or more slots having a plurality of sub-bands allocated to uplink and or downlink transmissions;
   determine whether to perform frequency hopping for a plurality of portions of an uplink transmission to be transmitted in one or more uplink sub-bands of the one or more slots;
   if it is determined that frequency hopping is to be performed for a respective portion of the uplink transmission, identify a frequency hopping offset and performing frequency hopping for the uplink transmission based on the frequency hopping offset; and
if it is determined that hopping is not to be performed for the respective portion of the uplink transmission, transmit the respective portion of the uplink transmission using a set of resource blocks for the uplink transmission.
32. Circuitry for an infrastructure equipment comprising:
   transceiver circuitry configured to transmit signals to and/or receive signals from a plurality of communications devices, and controller circuitry configured in combination with the transceiver to:
identify a sub-band format for one or more slots, the one or more slots having a plurality of sub-bands allocated to uplink and or downlink transmissions;
   determine whether to perform frequency hopping for a plurality of portions of a uplink transmission to be transmitted in one or more uplink sub-bands of the one or more slots;
   if it is determined that frequency hopping is to be performed for a respective portion of the uplink transmission, identify a frequency hopping offset and performing frequency hopping for the uplink transmission based on the frequency hopping offset; and
if it is determined that hopping is not to be performed for the respective portion of the uplink transmission, transmit the respective portion of the uplink transmission using a set of resource blocks for the uplink transmission.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] RP-213591, “New SI: Study on evolution of NR duplex operation,” CMCC, RAN #94e
[3] 3GPP TS 38.214, V16.0.0.

1. A method for a communications device configured to transmit signals to and/or to receive signals from an infrastructure equipment of a wireless communications network via a wireless radio interface provided by the wireless communications network, the method comprising:
identifying a sub-band format for one or more slots, the one or more slots having a plurality of sub-bands allocated to uplink and or downlink transmissions;
determining whether to perform frequency hopping for a plurality of portions of an uplink transmission to be transmitted in one or more uplink sub-bands of the one or more slots;
if it is determined that frequency hopping is to be performed for a respective portion of the uplink transmission, identifying a frequency hopping offset and performing frequency hopping for the uplink transmission based on the frequency hopping offset; and
if it is determined that hopping is not to be performed for the respective portion of the uplink transmission, transmitting the respective portion of the uplink transmission using a set of resource blocks for the uplink transmission.

2. The method of claim 1, further comprising:
determining that frequency hopping is to be performed for a portion of the uplink transmission; and
determining that frequency hopping is not to be performed for another portion of the uplink transmission.

3. The method according to claim 1, wherein the one or more slots include multiple uplink sub-bands of different widths.

4. The method according to claim 3, wherein the frequency hopping offset is different for different uplink sub-bands.

5. The method according to claim 1, wherein the one or more slots are one or more sub-band full duplex (SBFD) slots.

6. The method according to claim 1, wherein the one or more uplink sub-bands span an entire system bandwidth or bandwidth part (BWP).

7. The method according to claim 1, wherein the communications device derives the frequency hopping offset for an uplink sub-band based on a width of the uplink sub-band.

8. The method according to claim 1, wherein the frequency hopping offset is derived using a scaling factor.

9. The method according to claim 1, wherein determining whether to perform frequency hopping comprises determining whether a width of an uplink sub-band for the respective portion of the uplink transmission is above a predetermined threshold sub-band width.

10. The method according to claim 9, wherein the predetermined threshold width is a fixed number of resource blocks.

11. The method according to claim 9, further comprising receiving the predetermined threshold width from an infrastructure equipment of the wireless communications network.

12. The method according to claim 11, wherein the predetermined threshold width is included within frequency hopping parameters of a configuration message for the uplink transmission.

13. The method according to claim 1, wherein determining whether to perform frequency hopping comprises identifying whether frequency hopping is disabled for one or more portions of the uplink transmission according to a semi-static configuration.

14. The method according to claim 13, wherein the semi-static configuration defines whether frequency hopping is disabled for each sub-band configuration of the one or more uplink sub-bands.

15. The method according to claim 13, wherein the semi-static configuration defines whether frequency hopping is disabled for each of the one or more slots.

16. The method according to claim 13, wherein the semi-static configuration defines whether frequency hopping is disabled for each of a plurality of sub-slots, wherein the plurality of sub-slots are each a subset of OFDM symbols of a slot of the one or more slots.

17. The method according to claim 1, wherein determining whether to perform frequency hopping comprises determining, for the respective portion of the uplink transmission in an uplink sub-band, whether a number of resource blocks corresponding to a width of the uplink transmission are unused by another portion of the uplink transmission in the same uplink sub-band.

18. The method according to claim 1, wherein determining whether to perform frequency hopping comprises determining whether the respective portion of the uplink transmission utilises all resource blocks of an uplink sub-band.

19.-27. (canceled)

28. A communications device, the communications device comprising:
a transceiver configured to transmit signals to and/or to receive signals from an infrastructure equipment of a wireless communications network and/or one or more other communications devices, and
a controller configured in combination with the transceiver to:
identify a sub-band format for one or more slots, the one or more slots having a plurality of sub-bands allocated to uplink and or downlink transmissions;
determine whether to perform frequency hopping for a plurality of portions of an uplink transmission to be transmitted in one or more uplink sub-bands of the one or more slots;
if it is determined that frequency hopping is to be performed for a respective portion of the uplink transmission, identify a frequency hopping offset and performing frequency hopping for the uplink transmission based on the frequency hopping offset; and
if it is determined that hopping is not to be performed for the respective portion of the uplink transmission, transmit the respective portion of the uplink transmission using a set of resource blocks for the uplink transmission.

29.-30. (canceled)

31. An infrastructure equipment comprising:
a transceiver configured to transmit signals to and/or receive signals from a plurality of communications devices, and
a controller configured in combination with the transceiver to:
identify a sub-band format for one or more slots, the one or more slots having a plurality of sub-bands allocated to uplink and or downlink transmissions;
determine whether to perform frequency hopping for a plurality of portions of an uplink transmission to be transmitted in one or more uplink sub-bands of the one or more slots;
if it is determined that frequency hopping is to be performed for a respective portion of the uplink transmission, identify a frequency hopping offset and performing frequency hopping for the uplink transmission based on the frequency hopping offset; and
if it is determined that hopping is not to be performed for the respective portion of the uplink transmission, transmit the respective portion of the uplink transmission using a set of resource blocks for the uplink transmission.

32. (canceled)
